(19) United States
(12) Patent Application Publication
(10) Pub. No.: US 2014/0312849 A1
(43) Pub. Date: Oct. 23, 2014

(54) EXTERNAL BATTERY

(71) Applicant: SAMSUNG SDI CO., LTD., Yongin-si (KR)

(72) Inventors: Seok-Bong LEE, Yongin-si (KR); Ji-Yeon CHOI, Yongin-si (KR); Yeong-Mi KIM, Yongin-si (KR)

(73) Assignee: SAMSUNG SDI CO., LTD., Yongin-si (KR)

(21) Appl. No.: 14/192,985

(22) Filed: Feb. 28, 2014

(30) Foreign Application Priority Data
Apr. 18, 2013 (KR) 10-2013-0043022

(51) Int. Cl. H02J 7/00

(52) U.S. Cl. CPC H02J 7/0029; H02J 7/0068
USPC 320/134

(57) ABSTRACT

An external battery includes a battery, a charger, a DC-DC conversion, a main controller (MC), and a switch. The charger supplies, to the battery, external power supplied from an adaptor to an input stage. The DC-DC converter converts output voltage of the battery into voltage having an amplitude different from that of the output voltage and transmits the converted voltage to an output stage. The MC senses discharge overcurrent of the battery using an output current of the DC-DC converter. The switch is controlled by the MC and is between the battery and the DC-DC converter.

### CROSS-REFERENCE TO RELATED APPLICATION

Korean Patent Application No. 10-2013-0043022, filed on Apr. 18, 2013, in the Korean Intellectual Property Office, and entitled: “External Battery,” is incorporated by reference herein in its entirety.

### BACKGROUND

1. Field

Embodiments relate to a protection circuit of an external battery, and more particularly, to a protection circuit for preventing discharge overcurrent of an output terminal of an external battery.

2. Description of the Related Art

Electronic devices, e.g., a notebook computer, a cellular phone, a personal digital assistant (PDA) and the like have recently been developed to be potable. The potable electronic devices mainly receive electric energy necessary for use, supplied through batteries. The functions of the portable electronic devices have recently been diversified so that several functions can be performed with only one portable electronic device by adding other functions to the portable electronic device in addition to its unique functions. Therefore, the electric energy necessary for use is gradually increased, and accordingly, a basic battery having a larger capacity is required. To this end, an external battery has been developed, which can be used not by being attached to a portable electronic device but by being carried.

### SUMMARY

One or more embodiments are directed to providing an external battery, including: a battery; a charger supplying, to the battery, external power supplied from a travel adaptor to an input stage; a DC-DC converter that converts output voltage of the battery into voltage having an amplitude different from that of the output voltage, and transmitting the converted voltage to an output stage; a main controller (MC) sensing discharge overcurrent of the battery, using output current of the DC-DC converter; and a switch controlled by the MC, and disposed between the battery and the DC-DC converter.

The external battery may further include a current sensor disposed between the DC-DC converter and the output stage, and sensing the output current of the DC-DC converter.

When the sensed output current of the DC-DC converter reaches overdischarge current, the MC may turn off the switch to cut off the output voltage supplied from the battery to the DC-DC converter.

When the sensed output current of the DC-DC converter is dropped to the overdischarge current or less, the MC may turn on the switch.

The current sensor may include a current shunt resistor.

The MC may detect specifications of the travel adaptor coupled to the input stage, using the voltage of the input stage, and control the charger so that the maximum charge current according to the specifications of the adaptor is supplied to the battery.

The external battery may further include a display that displays the capacity of the battery. The MC may control the display using the voltage of the battery.

The DC-DC converter may boost voltage output from the battery and transmit the boosted voltage to the output stage.

When the output voltage of the battery reaches overdischarge prevention voltage, the MC may turn off the switch so as to cut off the output voltage of the battery.

When the output voltage of the battery drops to the overdischarge prevention voltage or less, the MC may turn on the switch.

The external battery may further include an overcharge prevention switch disposed between the input stage and the charger. When the output voltage of the battery reaches overcharge prevention voltage, the MC may turn off the overcharge prevention switch so as to cut off external power supplied from the input stage to the charger.

When the output voltage of the battery drops to the overcharge prevention voltage or less, the MC may turn on the overcharge prevention switch so that the external power is supplied from the input stage to the charger.

The external battery may further include a protection circuit module (PCM) circuit electrically coupled to the battery, the PCM circuit controlling at least one of overcharge, overdischarge and discharge overcurrent of the battery.

One or more embodiments are directed to providing an external battery, including a battery, a charger that supplies, to the battery, external power supplied from an adaptor to an input stage, a DC-DC converter that converts an output voltage of the battery into a voltage having an amplitude different from that of the output voltage, and transmits the converted voltage to an output stage, a main controller (MC) that senses a overcharge prevention voltage of the battery, and a switch between the input stage and the charger; the switch being controlled by the MC.

When the output voltage of the battery reaches the overcharge prevention voltage, the MC may turn off the switch to cut off external power supplied from the input stage to the charger. When the output voltage of the battery drops to the overcharge prevention voltage or less, the MC may turn on the overcharge prevention switch so that the external power is supplied from the input stage to the charger.

The external battery may include a protection circuit module (PCM) circuit electrically coupled to the battery, and controlling at least one of overcharge, overdischarge, and discharge overcurrent of the battery.

### BRIEF DESCRIPTION OF THE DRAWINGS

Features will become apparent to those of ordinary skill in the art by describing in detail exemplary embodiments with reference to the attached drawings in which:

FIG. 1 illustrates a block diagram showing an external battery according to an embodiment.

FIG. 2 illustrates a block diagram showing an external battery according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

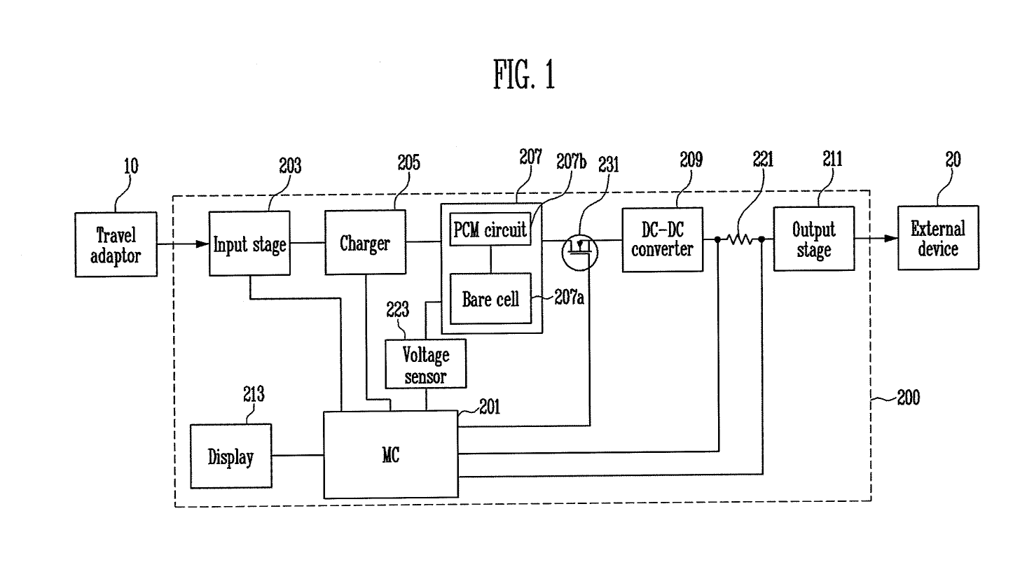

FIG. 1 illustrates a block diagram showing an external battery 200 according to an embodiment. Referring to FIG. 1, the external battery 200 may include a main controller (MC) 201, an input stage 203, a charger 205, a battery 207, a DC-DC converter 209, and an output stage 211.

The MC 201 generally controls components in the external battery 200. Hereinafter, the operating principle of the MC 201 will be described in detail together with other components.

The input stage 203 is a portion coupled to a terminal of an adaptor, e.g., a travel adaptor 10, and transmits, to the charger 205, external power supplied from the travel adaptor 10. The input stage 203 may be implemented in various forms according to the travel adaptor 10.

The charger 205 generates charge current, using external power supplied from the input stage 203, and supplies the generated charge current to the battery 207, thereby charging the battery 207. The amplitude of the maximum charge current output from the charger 205 may be changed depending on specifications of the travel adaptor 10 coupled to the input stage 203. Thus, the MC 201 can detect specifications of the travel adaptor 10 by sensing voltage that flows in the input stage 203, and control the charger 205 so that the maximum charge current according to the specifications of the travel adaptor 10 is output to the charger 205.

The battery 207 may include a bare cell 207a and a protection circuit module (PCM) circuit 207b electrically coupled to the bare cell 207a. The bare cell 207a is a rechargeable battery cell sealed inside a battery case in a state in which an electrode assembly having a positive electrode/separator/negative electrode structure is immersed in, e.g., a lithium electrolyte.

The electrode assembly is generally classified into a jelly-roll type (winding type) electrode assembly and a stacking type electrode assembly. The jelly-roll type (winding type) electrode assembly is formed by winding long sheet-shaped positive and negative electrodes each having an active material coated on both surfaces thereof in a state in which a separator is interposed between the positive and negative electrodes. The stacking type electrode assembly is formed by sequentially stacking a plurality of positive and negative electrodes with a predetermined size, each having an active material coated on both surfaces thereof in a state in which a separator is interposed between the positive and negative electrodes.

The bare cell 207a may include cylindrical and prismatic bare cells, in which an electrode assembly is accommodated in a battery case made of a metal can, and a pouch-type bare cell, in which an electrode assembly is accommodated in a battery case made of an aluminum laminate sheet, according to the shape of the bare cell. The bare cell 207a may have a structure in which two or more bare cells are coupled in series and/or parallel.

The PCM circuit 207b, electrically coupled to the bare cell 207a, controls the overcharge voltage, overdischarge voltage, and discharge overcurrent of the bare cell 207a, thereby protecting the bare cell 207a. The PCM circuit 207b may be any known PCM circuit.

The DC-DC converter 209 converts voltage output from the battery 207 into voltage with an amplitude for driving an external device 20 and transmits the converted voltage to the output stage 211.

The output stage 211 is coupled to the external device 20, so as to transmit, to the external device 20, electric power supplied from the battery 207. The output stage 211 may be implemented in various forms according to the external device 20.

A display 213 displays the capacity of the battery 207. The MC 201 may control the display 213 using the voltage of the battery 207.

The DC-DC converter 209 is a component that boosts the voltage output from the battery 207 in order to supply voltage necessary for the external device 20. Overcurrent may be generated in a process in which the voltage is boosted by the DC-DC converter 209.

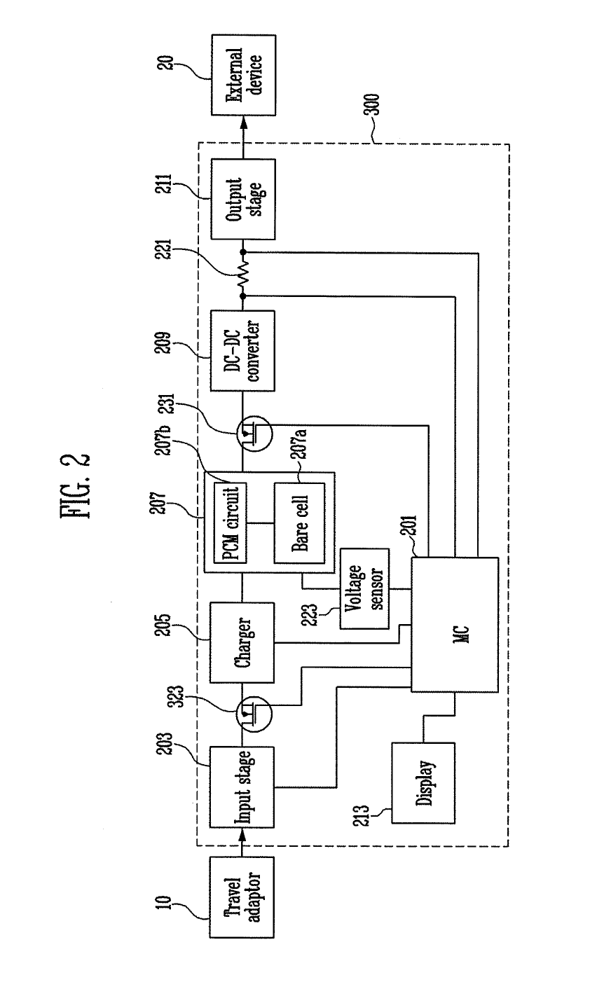

Thus, the MC 201 of the present embodiment may sense overcurrent flowing in the output stage 211 using output current of the DC-DC converter 209 and may control a switch 231 disposed between the battery 207 and the DC-DC converter 209. The switch 231 may be implemented with a transistor as shown in FIG. 2, but embodiments are not limited thereto.

In order to sense output current of the DC-DC converter 209, a current sensor 221 may be between the DC-DC converter 209 and the output stage 211. The current sensor 221 senses the amplitude of current output from the DC-DC converter 209 and transmits the sensed amplitude of the current to the MC 201. As shown in FIG. 1, the current sensor 221 may include a current shunt resistor. The current sensor 221 may sense current flowing in the DC-DC converter 209, using a potential difference between both terminals of the current shunt resistor.

When the output current transmitted from the current sensor 221 reaches the overdischarge current, the MC 201 turns off the switch 231 to cut off the output voltage supplied to the DC-DC converter 209. When the output current transmitted from the current sensor 221 drops to the overdischarge current or less, the MC 201 turns on the switch 231 so that the output voltage is supplied from the battery 207 to the DC-DC converter 209.

That is, the MC 201 of the present embodiment may control the switch 231 in accordance with the output current of the DC-DC converter 209, so as to cut off discharge overcurrent generated in the process in which the voltage is boosted by the DC-DC converter 290, thereby protecting the output terminal of the external battery 200.

Further, according to an embodiment, if the output voltage of the battery 207, transmitted from a voltage sensor 223 sensing the voltage of the battery 207, reaches an overdischarge prevention voltage, the MC 201 may turn off the switch 231 to cut off the output current of the battery 207. If the received output voltage drops to the overdischarge prevention voltage or less, the MC 201 can turn on the switch 231 so that the output voltage is supplied from the battery 207 to the DC-DC converter 209.

Thus, the MC 201 can control the overdischarge of the battery 207 even when the PCM circuit 207b does not control the overdischarge voltage of the battery 207 due to an error occurring in the PCM circuit 207b. Further, since specifications of the MC 201 can be changed using firmware, the MC 201 can control the overdischarge of the battery 207, using overdischarge prevention voltage having a value different from that of the overdischarge prevention voltage set in the PCM circuit 207b.

FIG. 2 illustrates a block diagram showing an external battery 300 according to another embodiment. Components of the external battery 300 shown in FIG. 3 are identical to those of the external battery 200 shown in FIG. 2, except that an overcharge prevention switch 323 is included, and therefore, their detailed descriptions will not be repeated.

Referring to FIG. 2, the overcharge prevention switch 323 may be disposed between the input stage 203 and the charger 205. When the output voltage of the battery 207, sensed by the voltage sensor 223, reaches the overcharge prevention voltage, the MC 201 may turn off the overcharge prevention switch 323 to cut off external power supplied from the input stage 203 to the charger 205. When the output voltage of the battery 207 drops to the overcharge prevention voltage or less, the MC 201 may turn on the overcharge prevention switch 323 so that external power is supplied from the input stage 203 to the charger 205.

Thus, the MC 201 can control the overcharge of the battery 207 even when the PCM circuit 207b does not control the overcharge voltage of the battery 207 due to an error occurring in the PCM circuit 207b. Further, since specifications of the MC 201 can be changed using firmware, the MC 201 can control the overcharge of the battery 207, using overcharge prevention voltage having a value different from that of the overcharge prevention voltage set in the PCM circuit 207b.

A related art external battery may include a main controller, a PCM circuit, and a DC-DC converter. In the related art external battery, a main controller may detect the kind of the travel adaptor used, control the output current of a charger, sense a voltage of the battery, and display the sensed voltage. However, in the related art, there are no switches between the battery and the DC-DC converter and/or between the input stage and the charger. Thus, the related art main controller cannot control the external battery in response to a discharge overcurrent output from the DC-DC converter and/or a voltage exceeding an overcharge prevention voltage being output from the battery. Therefore, in the related art, an overcurrent generated in the process of boosting voltage in the DC-DC converter cannot be prevented, which may result in heat being generated in the external battery and/or the electronic device may malfunction. Further, if the PCM circuit fails or if a value of an overcharge prevention voltage is desired to be lower than that set in the PCM circuit, the related art external battery could not address these issues.

However, in accordance with embodiments, the MC 201 may sense discharge overcurrent output from the DC-DC converter 209 and/or may determine whether a voltage output from the battery exceeds an overcharge prevention voltage and control switch(es) accordingly.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. An external battery, comprising:
a battery;
a charger that supplies, to the battery, external power supplied from an adaptor to an input stage;
a DC-DC converter that converts an output voltage of the battery into a voltage having an amplitude different from that of the output voltage, and transmits the converted voltage to an output stage;
a main controller (MC) that senses a discharge overcurrent of the battery using an output current of the DC-DC converter; and
a switch between the battery and the DC-DC converter, the switch being controlled by the MC.

2. The external battery as claimed in claim 1, further comprising a current sensor between the DC-DC converter and the output stage, the current sensor sensing the output current of the DC-DC converter and supplying the output current to the MC.

3. The external battery as claimed in claim 2, wherein, when the sensed output current of the DC-DC converter reaches an overdischarge current, the MC turns off the switch to cut off the output voltage supplied from the battery to the DC-DC converter.

4. The external battery as claimed in claim 3, wherein, when the sensed output current of the DC-DC converter drops to the overdischarge current or less, the MC turns on the switch.

5. The external battery as claimed in claim 2, wherein the current sensor includes a current shunt resistor.

6. The external battery as claimed in claim 1, wherein the MC detects specifications of the adaptor coupled to the input stage using the voltage of the input stage, and controls the charger so that a maximum charge current according to the specifications of the adaptor is supplied to the battery.

7. The external battery as claimed in claim 1, further comprising a display that displays the capacity of the battery, wherein the MC controls the display using the voltage of the battery.

8. The external battery as claimed in claim 1, wherein the DC-DC converter boosts a voltage output from the battery and transmits the boosted voltage to the output stage.

9. The external battery as claimed in claim 1, wherein, when the output voltage of the battery reaches an overdischarge prevention voltage, the MC turns off the switch to cut off the output voltage of the battery.

10. The external battery as claimed in claim 9, wherein, when the output voltage of the battery drops to the overdischarge prevention voltage or less, the MC turns on the switch.

11. The external battery as claimed in claim 1, further comprising an overcharge prevention switch between the input stage and the charger,
wherein, when the output voltage of the battery reaches an overcharge prevention voltage, the MC turns off the overcharge prevention switch so as to cut off external power supplied from the input stage to the charger.

12. The external battery as claimed in claim 11, wherein, when the output voltage of the battery drops to the overcharge prevention voltage or less, the MC turns on the overcharge prevention switch so that the external power is supplied from the input stage to the charger.

13. The external battery as claimed in claim 1, further comprising a protection circuit module (PCM) circuit electrically coupled to the battery, and controlling at least one of overcharge, overdischarge, and discharge overcurrent of the battery.

14. An external battery, comprising:
a battery;
a charger that supplies, to the battery, external power supplied from an adaptor to an input stage;
a DC-DC converter that converts an output voltage of the battery into a voltage having an amplitude different from that of the output voltage, and transmits the converted voltage to an output stage;
a main controller (MC) that senses a overcharge prevention voltage of the battery; and
a switch between the input stage and the charger; the switch being controlled by the MC.

15. The external battery as claimed in claim 14, wherein, when the output voltage of the battery reaches the overcharge prevention voltage, the MC turns off the switch to cut off external power supplied from the input stage to the charger.

16. The external battery as claimed in claim 14, wherein, when the output voltage of the battery drops to the overcharge prevention voltage or less, the MC turns on the overcharge prevention switch so that the external power is supplied from the input stage to the charger.

17. The external battery as claimed in claim 14, further comprising a protection circuit module (PCM) circuit electrically coupled to the battery, and controlling at least one of overcharge, overdischarge, and discharge overcurrent of the battery.
